(19) United States
(12) Patent Application Publication
(10) Pub. No.: US 2026/0298733 A1
(43) Pub. Date: Oct. 1, 2026

(54) Nozzle Force Sensor

(71) Applicant: Owen Bachyrycz, Kingston, MA (US)

(72) Inventor: Owen Bachyrycz, Kingston, MA (US)

(21) Appl. No.: 19/094,755

(22) Filed: Mar. 28, 2025

(51) Int. Cl. G01L 1/12; B29C 64/118; B29C 64/209; B29C 64/393; B33Y 30/00; B33Y 50/02

(52) U.S. Cl. CPC G01L 1/127; B29C 64/118; B29C 64/393; B33Y 30/00; B33Y 50/02; B29C 64/209

(57) ABSTRACT

The Nozzle Force Sensor is a 3D printer component which measures forces on the printer's hotend. This force data can be used to level the print surface, detect filament jams or when the printer runs out of filament, and compensate for filament extrusion inconsistency, all to improve print reliability and print quality.

### CROSS-REFERENCE TO RELATED APPLICATIONS

This non-provisional patent application is relevant to provisional patent 63/572,330.

### BACKGROUND OF THE INVENTION

This invention relates to additive manufacturing (3D printing), and more specifically, to sensing forces on the 3D printer's hotend to improve printing performance.
Before this there have been prior solutions such as using a load cell on the 3D printer's toolhead to sense forces.
Other available solutions were not accurate enough and were too bulky, introducing mechanical weaknesses.
The load cell is similar but does not do what the nozzle force sensor does-most printers operate without force feedback which makes it so you have to manually tune a lot of settings to make it print properly.

### SUMMARY OF THE INVENTION

An FDM (Fused Deposition Modeling) 3D-Printer using a motor (extruder) to push plastic filament through a heater (commonly called a hotend) and a nozzle to create a consistent flow of molten plastic. The hotend and nozzle is moved by the 3D-Printer's motion system to extrude this molten plastic onto a heated print surface in precise locations to form a solid, 3-dimensional object.

This Inductive force sensor is positioned between the hotend and the extruder of the 3D-Printer and measures the forces acting on the hotend from the extruder and the environment. The force readings from this sensor can be used in many ways to make the 3D printer more effective.

The force sensor functions by mounting the hotend to a stiff steel spring that allows the hotend to move slightly when force is applied to it. A sensitive electromagnetic coil is used to detect this slight movement, and then an integrated circuit records this data and sends it to the 3D-Printer's control board. The 3D-Printer can now modify its behavior according to the information from the sensor.
Solves leveling the heated build surface (tramming the build surface), detecting if the filament jams or runs out, and compensating for variations in the flow of molten filament to improve print quality.
The nozzle force sensor is different from other inventions because they are not as accurate because the sensing technology they use is less precise, and because they are simpler devices they give less information (do not measure molten material flow or sense filament jams) because other devices are not as precise and cannot be mounted in a way that allows them to sense the same information. Typically, contemporary solutions would only solve one of the problems that this device solves. Machines would require multiple devices to do what this does in one lightweight small component without the unique features.

### BRIEF DESCRIPTION OF DRAWINGS

FIG. 1: Section view of 3D printer extrusion path with inductive force sensor

FIG. 2: Side view of 3D printer extrusion system with inductive force sensor

FIG. 3: Exploded view showing all of the components of a 3D printer extrusion path with the force sensor integrated between the hotend and the extruder.

### DETAILED DESCRIPTION OF THE INVENTION

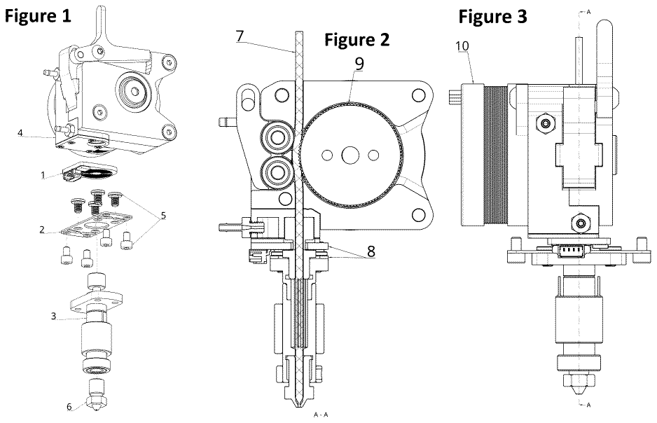

An FDM (Fused Deposition Modeling) 3D-Printer using a motor (extruder, FIG. 1, detail #4) to push plastic filament (FIG. 2, detail #7) through a heater (commonly called a hotend, FIG. 1, detail #3) and a nozzle (FIG. 1, detail #6) to create a consistent flow of molten plastic. The hotend and nozzle are moved by the 3D-Printer's motion system to extrude this molten plastic onto a heated print surface in precise locations to form a solid, 3-dimensional object.

This Inductive force sensor is positioned between the hotend and the extruder of the 3D-Printer and measures the forces acting on the hotend from the extruder and the environment. The force readings from this sensor can be used in many ways to make the 3D printer more effective.

The force sensor functions by mounting the hotend to a stiff steel spring (FIG. 1, detail #2) that allows the hotend to move very slightly when force is applied to it. A sensitive electromagnetic coil (FIG. 1, detail #1) is used to detect this slight movement, and then an integrated circuit (also FIG. 1, detail #1) records this data and sends it to the 3D-Printer's control board. The 3D-Printer can now modify its behavior according to the information from the sensor.
A simple way that this data can be used is to detect when the nozzle has collided with another object, for example, the print surface. Detecting when the nozzle contacts the print surface allows the printer to automatically adjust the nozzle to the correct height for printing. The printer can also move the nozzle to different locations and repeatedly contact the print surface to detect variations in the height of the print surface and compensate for these variations, ensuring that the nozzle is always at the correct height even if the print surface is warped or uneven. The nozzle being the correct distance from the print surface is incredibly important because if it is too far away or too close, the extruded plastic may not adhere to the print surface properly and cause a failure.
There are other existing devices that aim to achieve this purpose but have significant shortcomings. Many devices use a separate probe that contacts the print surface or a distance sensor to detect how close the bed is to the nozzle. These devices are inferior to this inductive force sensor because they are separated from the nozzle, so they must be calibrated to adjust for their displacement from the nozzle. Additionally, these devices must be calibrated again when changing printing temperature because the nozzle changes in size due to thermal expansion, throwing off the calibration. Changing nozzles also requires recalibration on other sensors because different nozzles may have different geometries. Some devices use force sensing load cells in the print surface or motion system to avoid these issues, but are 100-1000× less precise than this inductive force sensor and are solely used for detecting the nozzle contacting the bed, whereas the inductive force sensor is far more precise and capable of more functions. Additionally, these other solutions are often bulky, heavy, and mechanically complicated compared to the inductive force sensor which is just the two small parts, the spring mount, and the sensing coil.
Since the inductive force sensor is between the hotend and extruder, it can detect with how much force the extruder is pushing the filament into the hotend. This has several uses. If the force sensor detects a sudden spike in force, it is likely that there is a clog in the nozzle and the extruder pushing with its full strength but still failing to extrude any plastic. Once the sensor detects this, the printer can then pause printing and alert the user to the jam in the nozzle and allow them to clear it. If the force sensor detects a drop in force, it is likely that the extruder is jammed or has run out of filament, preventing the extruder from pushing filament into the hotend. Once again, the printer can pause itself and alert the user to resolve the issue. Without these functions the printer would not have been aware of any issues and would continue printing normally while failing to extrude, resulting in a print failure, wasted print time, and possible damage to the extruder. Thanks to the inductive force sensor this will not happen, and once the user fixes the issue the print can resume and successfully complete the print. There are other devices on the market that aim to serve the same purpose but they function by detecting the movement of filament as it is being pulled into the extruder which means they fail to detect partial clogs or extruder jams since the extruder can still be pulling filament but not extruding the right amount, resulting in an undetected print failure. These other devices are also a separate component often consisting of many parts, whereas the inductive force sensor serves this purpose and while taking up less space, adding less weight, and being simpler to manufacture and assemble.
Thanks to the exceptional precision of this inductive force sensor, it can also be used for real time adjustments in extruder pressure to improve the consistency of filament extrusion. There are many variables when extruding filament in FDM printing. Different filaments have varying flow characteristics, the diameter of the filament is inconsistent, different additives for color and mechanical properties, and printer settings affect how the filament flows. This often results in errors while printing such as over extruding in corners, gaps in the extruded plastic, and under or over extruding, all of which have negative effects on the strength and quality of the print. There are current software solutions for compensating for these variables, often called “pressure advance” or “linear advance.” However, these solutions rely on manual calibration, are different for every filament, and cannot compensate for factors like inconsistent filament diameter. This results in a lot of manual work for the user and inconsistent printing results. Since the inductive force sensor provides such precise force information the printer can constantly adjust the extruder to maintain a constant force and therefore constant filament flow despite all the mentioned variables. This results in superior appearance and more reliable mechanical properties for 3D Prints.

What is claimed is:

1. The nozzle force sensor measures forces on the 3D printer's hotend, and that data can be used to make the 3D printing process more reliable and accurate in a small, lightweight package.

2. The nozzle force sensor sends data to the 3D printer software, which can then adjust extruder parameters to compensate for variations in the flow of molten filament, which improves print quality.

3. The data from the nozzle force sensor can be used in other ways such as tramming the build surface, detecting filament jams, and when the printer runs out of filament, all of which would require discrete components in a typical system.
